(19) United States
(12) Patent Application Publication
(10) Pub. No.: US 2017/0140487 A1
(43) Pub. Date: May 18, 2017

(54) STUDENT GRADUATION REQUIREMENTS RECORDS SYSTEM AND METHOD

(71) Applicants: Arturo Caines, Hanover Park, IL (US); Gerald Hajduk, Glendale Heights, IL (US); Lenin John, Hamilton (CA); Samuel Zita, Woodridge, IL (US)

(72) Inventors: Arturo Caines, Hanover Park, IL (US); Gerald Hajduk, Glendale Heights, IL (US); Lenin John, Hamilton (CA); Samuel Zita, Woodridge, IL (US)

(21) Appl. No.: 14/943,193

(22) Filed: Nov. 17, 2015

(51) Int. Cl. G06Q 50/20; G06Q 10/10

(52) U.S. Cl. CPC G06Q 50/2053; G06Q 10/10

(57) ABSTRACT

An integrated system and method, used by a post-secondary educational institution such as a college or university, that tracks the aggregate student population's progress towards reaching their chosen degree at said educational institution. Degree requirements are reduces to a set of combined algebraic and Boolean expressions that, when met, indicate the student has met the graduation requirements. The student's transcript is used to populate the expression, allowing an analysis of still needed coursework. The system and method comprises aggregating all of the completed coursework for the post-secondary educational institution's current student population, to allow the institution to plan curriculum.

### FIELD OF INVENTION

This invention relates to the field data processing for education administration, guidance, and admission. Specifically, this invention is a system and method to compare and contrast student records against graduation requirements.

### BACKGROUND OF INVENTION

Due to the silo-like organization of most post-secondary educational institutions, the database systems within most such institutions are often separately partitioned and incompatible. This has many negative implications for these institutions. Perhaps none more troublesome than the inability to properly track student progress versus graduation requirements, and therefore, plan the appropriate course selection for future semesters or trimesters.

Currently, most post-secondary educational institutions have a database containing a student's transcript. In order to graduate, it is incumbent on the student to track their progress towards their graduation requirements. When the student meets their graduation requirements, they file the appropriate paperwork with their college registrar, or equivalent. In many institutions, the graduation paperwork is forwarded to the college containing the student's degree program. The college containing the student's degree program then approves the student for graduation and forwards the paper back to the registrar. Such an information-pull system is inefficient and prone to mistake. Further, future planning on needed courses is totally disconnected from the systems containing the students transcripts: the master database for what courses have been completed.

As a result, most post-secondary educational institutions create course forecasts based on largely inaccurate or manual data. Many times, the institution will merely repeat what they offer, over and over, semester after semester. Many students can attest to the result. Many of the classes needed for graduation are difficult to get into. Additionally, many classes are cancelled the first week of school due to a lack of interest. The inefficiency caused by such a system is substantial.

The Federal Department of Education (“DOE”) is the largest single post-secondary education funding source in the United States. DOE has implemented standards which track the 6 year graduation rates of students. Such measures are difficult for many colleges to answer, accurately and automatically, due to their data systems. Additionally, such measures place community colleges at a distinct disadvantage, for a number of reasons. First, many students who start their post-secondary education at a community college, eventually transfer to another institution. Second, many of the students at a community college are only attending part-time, meaning that it can take significant time for the student to achieve a four-year degree. Third, many of the students at community colleges are adult learners, who do not intend to get a degree. Rather, they are attending community college to improve their knowledge, improve their job skills, or for simple edification.

In a March 2015 report by the American Association of Community Colleges, only 26.1% of the students who first enroll at a community college achieve their initial degree at that same institution within six years. However, over 57% of the students who first enroll at a community college, either (1) achieve their initial degree at the same institution within six years; (2) complete their degree at a different four year institution within six years; (3) achieve their initial degree at a different two year institution within six years; or (4) are still enrolled in an post-secondary educational institution.

With the DOE requiring higher six year degree completion rates, community colleges need a tool that allows them to track the continuing education of students who begin post-secondary education at their institution. However, the graduation requirements, courses requirements, course descriptions, and curriculum varies significantly between institutions. This significantly hinders community colleges in their effort of trying to track the future education of their former students.

A significant part of this problem is that post-secondary educational institutions of every variety also have an inability to accurately forecast and schedule classes that are needed by students to graduate. Without exception, one of the biggest complaints of post-secondary students is getting “closed-out” of a required class. Post-secondary institutions are forced to set up either automated or manual heuristics to insure that more senior students receive preferred access to such courses.

Additionally, post-secondary students have a vested interest in tracking the graduation requirements of their degree program at their college or university. For a significant portion of the population of post-secondary students, the high rate of inflation for post-secondary education has forced them to begin at community colleges, before transferring to a four year institution. These cost-conscious students want to maximize the number of classes taken at low-cost institutions, such as community colleges. Some of the cost-conscious students begin with a plan, understanding which classes they will take at the community college, and what university they will transfer to in the future.

For these cost-conscious students, the ability to know what classes are offered at a community college, and how they fit into a degree program at a different institution, is paramount. These students read course catalogs for both institutions, and try to divine what may, and what may not, transfer. At best, this is a headache. Adding to the headache, many students change majors, or interest, while in college. These students need a tool that allows them to track graduation requirements at various institutions, and compare the graduation requirements of various degree programs using their completed and current coursework.

Additionally, many other cost-conscious students begin their post-secondary education without a clear vision of how they will finish their post-secondary education. For these students, post-secondary progress is an ad hoc activity, in which the student fitfully advances towards an amorphously defined future. These students also need a tool that allows them to track graduation requirements at various institutions, and compare the graduation requirements of various degree programs with their completed and current coursework. To maximize utility, such a tool should allow the user to compare various degree programs at various institutions, allowing a student to assess which institution and degree program is most advantageous, given the students completed coursework and financing. Currently, the solutions are painfully manual.

### PRIOR ART REVIEW

In order to overcome the large problem, that of disjointed databases containing transcript information and degree requirements information, making it difficult to know the current status of an individual student or an entire student population with respect to degree requirements, a system is needed that can convert transcript information and degree program information into an actionable decision making information package. The idealized solution to the above problem would allow both post-secondary institutions and students to optimize their schedule, and it would allow the post-secondary institution to track the progress of its former student, while simultaneously allowing the student population to compare and contrast graduation paths at various post-secondary institutions. Such a solution would begin with a method of coding, into logic, current degree requirements of a post-secondary institution, a method to classify the uses that each class may be used for in meeting degree requirements, a method to aggregate and compare current degree requirements of currently enrolled students to what each student has taken, a method to aggregate the requirements remaining for the population of active students, and a method for mapping the remaining requirements onto the set of classes, honoring the various uses for which the classes may be used. Students would be tracked with an application that can be loaded onto a smartphone or other portable electronic device. The application would associate a student with a permanent record, allowing post-secondary institutions to track their students for DOE reporting purposes. The application would allow the student-users to compare and contrast the graduation requirements of various degree programs and institutions, by querying a plurality of servers and databases that contain the graduation requirements for a variety of degree programs at a variety of institutions, and compares them to the user's completed coursework, which is stored, either locally on the phone, or on a remote server and database. The application should be able to compare the path to completion for a variety of institutions and degree programs. The application should also allow the participating institutions to track the educational progress of the user population.

There is a substantial amount of prior art that touches on various aspects of an idealized system, but nothing that comes remotely close to delivering the entire solutions. A number of patents disclose various aspects of systems to schedule post-secondary classes. For example, U.S. Pat. No. 7,805,107, by named inventor Shaver, is entitled, “Method of student course and space scheduling” (“Shaver '107”). Shaver '107 teaches a method of determining student demand for academic courses during a variety of time periods and a method of scheduling the student demand for academic courses for academic programs of study. Shaver '107 basically discloses an automated method for course scheduling based on historical requirements. Shaver '107 teaches the aggregation of historical student class selection and assignment, and extrapolates that on new sample of students. For example, Shaver '107 would look at the historical data for junior biology majors. Then it would assume that the next years of junior biology students are going to behave in a similar manner to the previous, historical data. Shaver '107 also discloses a concept of qualified courses. A qualified course is the set of courses all active students need to take, and which they are currently qualified to take. Shaver '107 teaches a system that would then take the extrapolation of historical student selection and assignment behavior and extrapolate that on the set of qualified courses to determine a demand.

There are several problems with Shaver '107. First, Shaver '107 anticipates that the post-secondary institution gives it the degree requirements. This is often a time consuming task, and one that, if performed manually, is fraught with potential error. Second, Shaver '107 anticipates that the course requirements will be provided in a fashion that will allow the computer to determine a population of still-required courses. The reality of modern post-secondary education is that many classes can fit multiple graduation requirements for multiple degree programs. In order to optimize scheduling, a solution must somehow map all of the uses for which each class can be used for each offered degree program. In addition to deficiencies with the schedule aspects of Shaver '107, it does not give students unfettered access to a planning facility that allows the student to compare and contrast future course offerings. Neither does Shaver '107 track students as they move from one institution to another institution. Although an interesting piece of prior art, Shaver '107 is a sub-optimal solution for several reasons.

Another patent disclosing a scheduling method for post-secondary institutions is U.S. Pat. No. 8,224,757, by named inventor Bohle, entitled, “Curriculum management system” (“Bohle '757”). Bohle '757 teaches class scheduling software that allows users to sign up for classes, creates an attendance link, and associates each course with a particular curriculum. Bohle '757 teaches a method in which, when modifications are made, the system determines whether only a single individual is changing their class, or whether the entire class is being re-scheduled. Bohle '757 teaches a novel link between an attendance function and a scheduling function. Bohle '757 does not teach significant aspects of an idealized solution, such as the determining which classes should be offered based on the aggregate student degree program requirements, and the aggregated currently completed courses. Bohle '757 does not teach software coding, or any other method of capturing aggregate degree requirements. Bohle '757 only teaches using links to adjust student class schedules when a particular class offering changes or is cancelled.

A third patent focused on scheduling an educational institution is U.S. Pat. No. 7,882,041, by named inventors Gibbons, et. al., is entitled, “System and method for optimizing the effectiveness of an educational institution” (“Gibbons '041”). Gibbons '041 teaches a system and method for taking course selection input from a student body population, aggregating the overall course demands, and then making a plan to dynamically allocate resources to meet the overall course requirements. Gibbons '041 discloses that the system reallocates resources based upon certain triggers. The triggers can be expiration of a certain time interval, a change in available resources, or a change in student population. Gibbons '041 does not address most of the issues in the market. Gibbons '041 merely takes student input and schedules classes. Gibbons '041 fails to hard code the overall requirements of an institution; and it fails to determine the aggregate course need, now and in the future, for the current student population based off of the graduation requirements of the student body. Most of the scheduling patents suffer the same types of problems as Shaver '107, Bohle '757, and Gibbons '041. Further recitation would be merely cumulative.

There are patents that attempt to provide cross-institutional curriculum management, such as U.S. Pat. No. 8,620,831, by named inventor Adams, entitled, “Student-centered, cross-institutional curriculum management system apparatus and method” (“Adams '831”). Adams '831 teaches a system and method that compares curriculum between institutions, mining course catalogs for requirements. Adams '831 then translates like-text into like-requirements, between institutions. A student can then plan out a degree program at a first educational institution, while taking classes at both a first educational institution and a second educational institution. The schedule meeting the student's preset requirement for attaining a desired degree, taking a particular course load, and going to school on particular days and times. Although Adams '831 is an interesting concept, it requires a third party to intermediate the catalog offerings of the first educational institution and the second educational institution. The third party would delimit the text of the course catalog offerings of the educational institutions, would define XML labels for analogous text, and would have the educational institutions embed the XML labels in their respective online catalogs. Adams '831 moves the prior art in an interesting direction, but it is difficult to get many large institutions to agree to embed XML text on their webpages. Adams '831 is of limited use because it also does not help the educational institutions to track the future education of the student. The system itself will never be widely implemented because of those impediments.

A couple of related credentialing systems have interesting aspects, U.S. Pat. Nos. 8,554,584 and 8,290,797, both by named inventor Hargroder, both entitled, “Interactive credential system and method” (“Hargroder '584” and “Hargroder '797”). Hargroder '584 and Hargroder '797 are concerned with insurance credentialing or underwriting. These patents disclose a credential system and method comprising a database containing employee-employer-applicant surveyed information, industry specific criteria, such as insurance loss history and account performance, an authorization code for authorizing access to the database and a control device, operatively associated with the database, for presenting weighted scores. Hargroder '584 and Hargroder '797 teach a method and system for reducing an entity's or person's insurance loss history and account performance to a single numeric metric. These patents, although in an unrelated field, disclose a method for authorizing the access of confidential information stored on a plurality of databases by a plurality of institutions. Hargroder '584 and Hargroder '797 also teaches updating or augmenting loss information of an entity or person, stored by one institution, with the loss information of a second institution.

A last piece of relevant prior art are those systems that match student records across institutions, such as U.S. Pat. No. 8,676,823, by named inventors Shapiro, et. al., entitled, “Efficient student record matching” (“Shapiro '823”). Shapiro '823 teaches a system and method for matching student enrollment records. The method comprises accessing a student's enrollment record at a first educational institution, creating common variations in the spelling of the student's name, and searching additional educational institutions for additional records. The method relies on a historical name variation database. In a preferred embodiment, Shapiro '823 uses a matching algorithm to account for common variations in student names and geographical distances between secondary institutions and the student's current known address to generate higher confidence matches. Shapiro '823 is envisioned as allowing educational institutions to track student progress from secondary to postsecondary institutions and generate statistics about aggregate college enrollment rates to inform policy decisions. Shapiro '823 does not aggregate records between a plurality of post-secondary institutions for the same student, although, conceivably, it could. Shapiro '823 merely provides a method for record matching, and exemplifies the prior art with respect to that aspect of its design.

In addition to the above cited patents, and others like them, there are commercial solutions in the prior art. One is the Oracle's/PeopleSoft's Campus Solutions. As with most comprehensive solutions, Campus Solutions is both overly broad and underly capable. Campus Solutions tries to be an end-to-end people and process management solution for universities, managing enrollment, degree tracking, financial aid, and other university management functions. The package includes multiple modules that can be added on to customize a solution. In the end, the solution does not allow an institution to track its former students progress at other institutions. It also fails to provide students with a tool to compare and contrast the remaining requirements for graduation in different degree programs. Perhaps the biggest drawback is that Campus Solutions does not appear to have a method to determine the aggregate remaining courses for either a single student or a student population.

The prior art has failed to create a complete solution to the inter-related problems of determining the remaining courses required, both individually, and in the aggregate, in order to meet graduation requirements, tracking post-secondary student progress through multiple institutions, and assessing graduation requirements for a particular student with respect to a plurality of post-secondary educational institutions and/or a plurality of degree programs. Because of the heightened reliance, in the United States, on community colleges as part of the solution for the high cost of post-secondary education, student tracking and graduation requirements tracking have become a merged issue, which is exacerbated by the inefficiencies in the post-secondary educational institutions' databases.

### SUMMARY OF THE INVENTION

The present invention is an integrated system and method that tracks the aggregate student population's progress towards reaching their chosen degree at an educational institution. One embodiment allows for the tracking of a plurality of post-secondary students' educational progress, while allowing the students and educational institutions to more accurately plan class requirements based off of the student populations already completed coursework.

The system and method comprises aggregating all of the completed coursework for the post-secondary educational institution's current student population.

The system and method hard codes degree requirements in software, converting them into Boolean and/or algebraic expressions. The expressions have Boolean aspects because the student has either taken a required course or has not taken a required course. Or the student has met a pre-requisite to take or course, or has not met a pre-requisite to take the course. Some expressions are combined algebraic and Boolean expressions, because, for example, a student might be required to take three English course or three math courses. The requirement is only met once the student has taken all the courses, but each completed course still counts toward a graduation requirement for credit hours. For lack of a more elegant term, the requirement equations and equation sub-components will be referred to algebraic Boolean expressions. The total credit hour requirement for graduation is an algebraic Boolean sum. In some degree programs, there may be intermediate algebraic Boolean sums, when a degree program requires a major or minor with a particular number of credit hours. Each degree program can be defined as a set of required and elective courses, until the student reaches a pre-set number of credits.

The requirements for each degree program are publically available for all post-secondary institution, and typically reside in the post-secondary institution's course catalog or website. Each class relates to each degree program in one of a number of defined ways, called uses, such as prerequisite, requirement, elective, or no relationship. Often, a class may meet one or more uses for a specific degree program, but may only be used for a single use, meaning that logic must be used to determine the most advantageous use for each class for each student. The set of all uses for all degree programs for a specific course is defined as the course's universe. A text engine can be used to translate the course requirements into logic requirements.

The system and method can calculate the minimum required set of classes required for each student in attendance, by maximizing the degree program uses for the student's completed coursework. Such an optimization routine can be accomplished by loading all possible course use algebraic Boolean expressions for a given student into a matrix, solving for the minimum or maximum. The system and method then aggregates the set of all of the classes needed to satisfy all of the remaining requirements for the student population. Each student can then track their progress towards graduation. Additionally, each institution can monitor each student's progress towards degree completion.

The post-secondary educational institution then uses the aggregated set of all of the classes needed to satisfy all of the remaining degree requirements for the student population as the basis for scheduling the various classes. In one embodiment, this information is used for curriculum forecasting. The curriculum forecasting aspect can be augmented by determining the temporal interrelationship between classes. The temporal interrelation of course universes is calculated, by comparing prior semesters of course completion to determine which classes were typically taken before, simultaneously with, or after each other course.

In one embodiment, a plurality of post-secondary institutions are all similarly enabled with an integrated system and method that tracks the aggregate their student population's progress towards reaching their chosen degree. In a system with a plurality of post-secondary institutions, each post secondary institution can be authorized to see the academic progress of students who formerly attended their institution. Likewise, students can see the graduation requirements for degree programs at other post-secondary educational institutions, and can use their completed course work to analyze the path needed to graduation in various degree programs at various post-secondary educational institutions.

### BRIEF DESCRIPTION OF THE DRAWINGS

There are 8 relevant drawings.

FIG. 1 is high-level system diagram showing the functional blocks and the connections/circuitry.

FIG. 2 shows the logic Framework stack.

FIG. 3 shows the System Management functional blocks.

FIG. 4 shows the GUI Client.

FIG. 5 shows the Loader flow and functional block.

FIG. 6 shows the Degree Analyzer flow and functional block.

FIG. 7 shows the Curriculum Analyzer flow and functional block.

FIG. 8 shows the analytic engine/metadata views.

### DETAILED DESCRIPTION OF THE PREFERRED EMBODIMENTS

The following description represents the inventors' current preferred embodiments. The description is not meant to limit the invention, but rather to illustrate its general principles and utility. Examples are illustrated with the accompanying drawings. A variety of drawings are offered, showing multiple system components and multiple embodiments of the present invention.

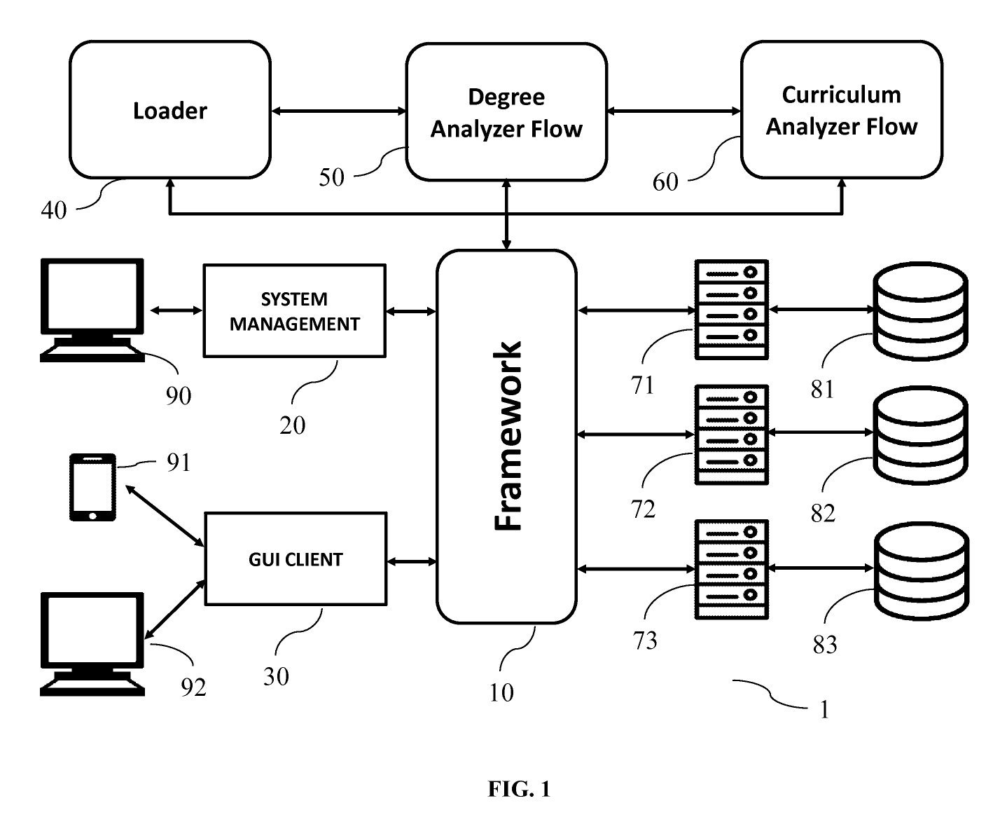

FIG. 1 shows the overall system diagram for the present invention. The invention allows input and access from users on computers/laptops 92 or mobile devices 91 through a graphic user interface (“GUI”) client 30. The invention allows post-secondary educational institution (“college”) administrators to control users and system management 20 from computers/laptops 90.

The system of the present invention is controlled and operated through a framework 10. The framework 10 is connected to a plurality of college servers 71, 72, 73. The connections are a combination of software and circuitry, that can vary from college to college. The plurality of college servers 71, 72, 73 connects the framework to their database repositories 81, 82, 83. The database repositories 81, 82, 83 store data on students, curriculum, and degrees, inter alia. The framework allows the loader 40, degree analyzer operation 50, and curriculum analyzer operation 60 to interact with, and create transforms of, the college data on students, curriculum, and degrees.

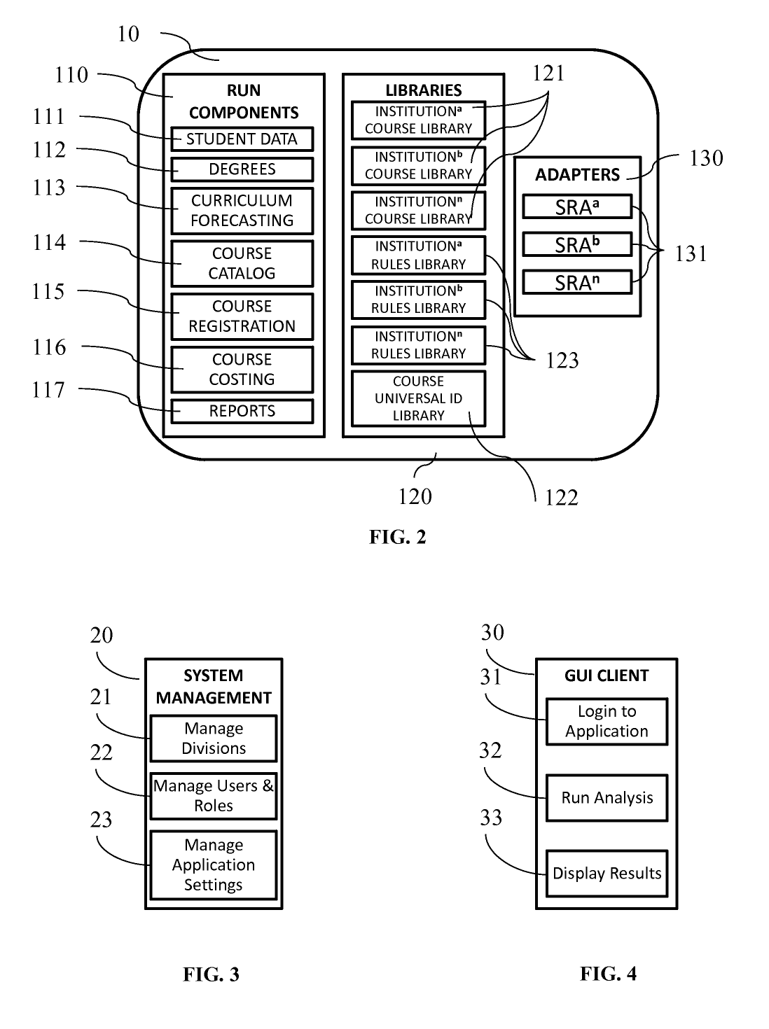

FIG. 2 shows the major components of the framework 10: the run components 110; the libraries 120; and the adapters 130. The run components 110 include student data 111; degrees 112; curriculum forecasting 113; course catalog 114; course registration 115; course costing 116, and reports 117. The run components use the libraries 120, the loader 40, the degree analyzer operation 50, the curriculum analyzer operation 60, and the adapters 130. The libraries 120 include an institution course library 121 for each of the plurality of colleges. The libraries 120 also include an institution rules library 123 for each of the plurality of colleges. Lastly, the libraries 120 include a course universal ID library, which can allow for cross-referencing different course offerings between different colleges. The adapters includes a system of records adapter (“SRA”) 131 for each of the plurality of colleges. The SRA 131 acts as an adaptation layer, putting all of the plurality of colleges' information into a standard information presentation format for processing.

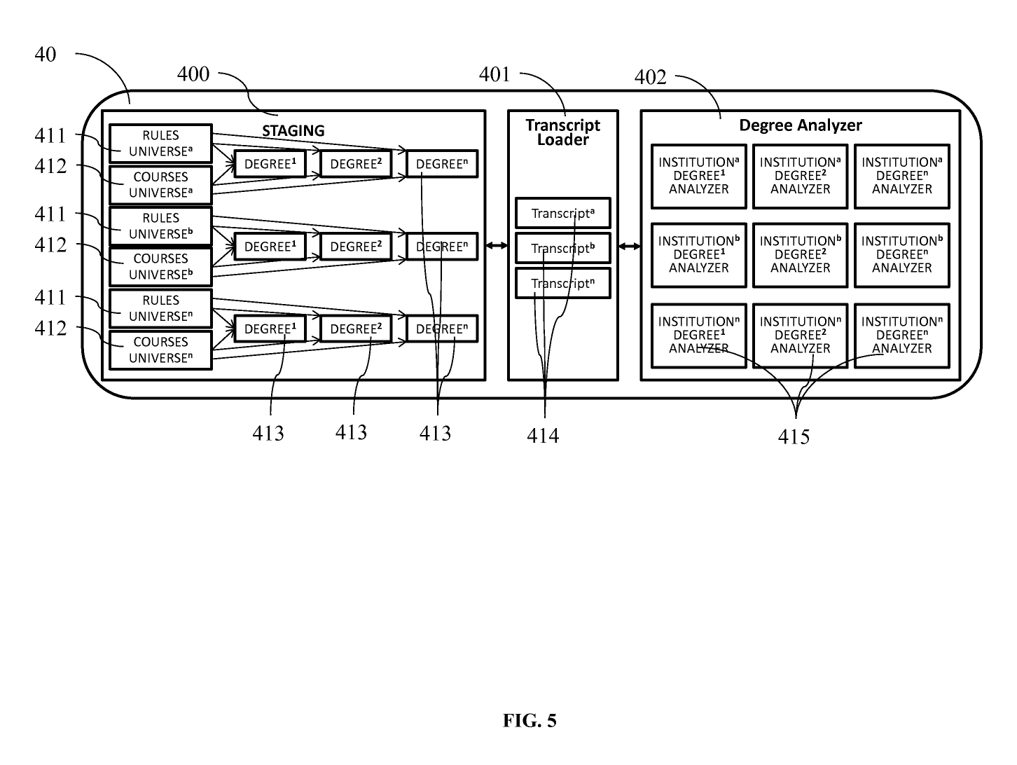

In FIG. 3 and FIG. 4, the system management stack 20, and the GUI client 30 serve as an interface to the present invention, and interact with the framework 10. The system management stack 20 includes a division management function 21, a facility to manage users and roles 22, and a facility to manage application settings 23 for a particular college or institution. The GUI client 30 includes a login 31, a run analysis interface 32, and a results display 33.

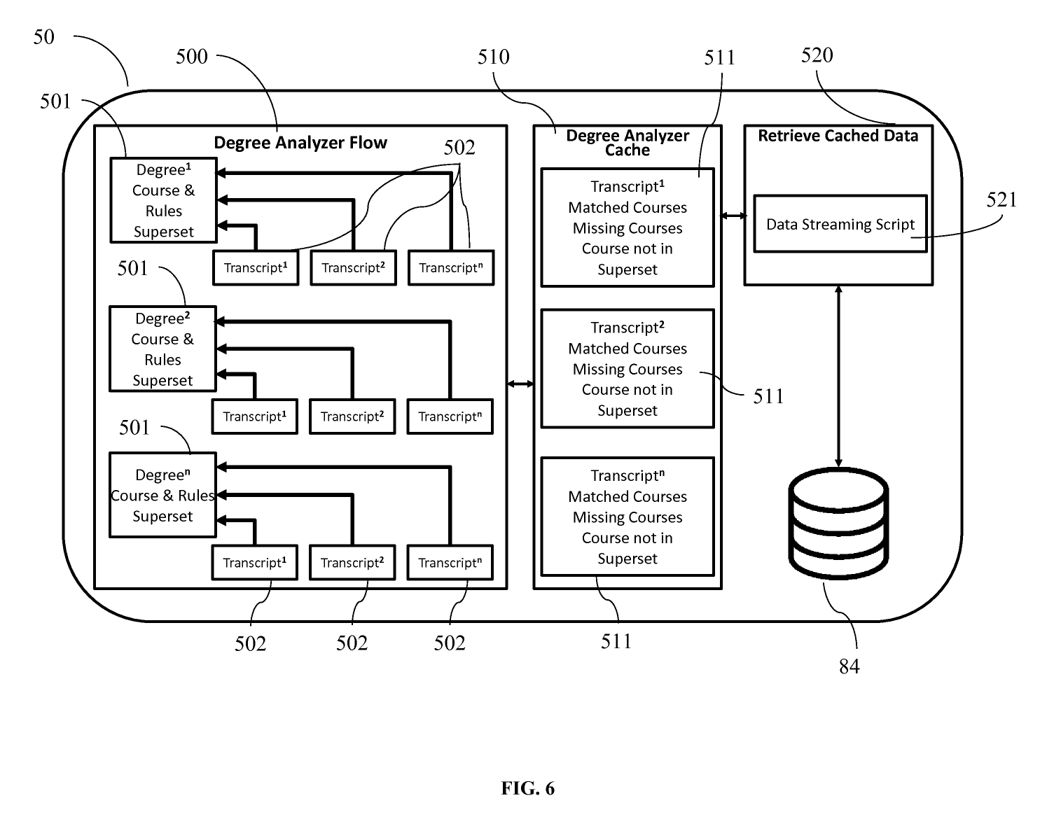

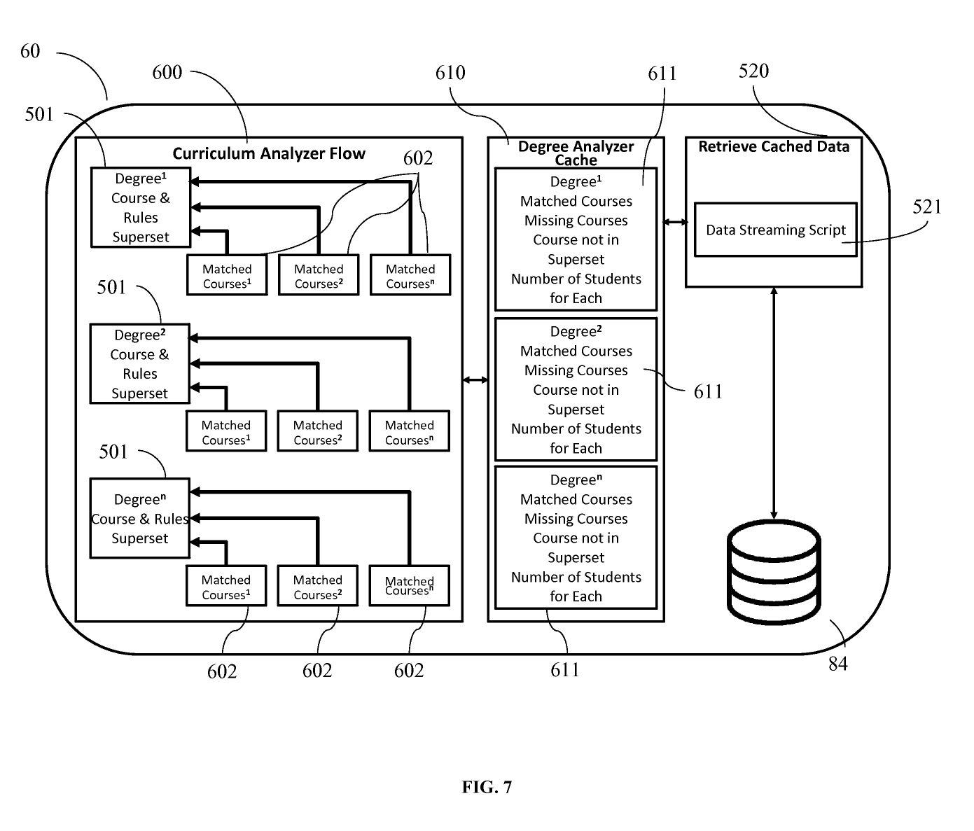

FIG. 5 shows the loader 40, which interacts with the framework 10, the degree analyzer operation 50, and the curriculum analyzer operation 60. The loader has a staging method that includes a rules universe 411 and a course universe 412 for each college. The rules universe 411 defines all of the requirements that a college or university can have. The courses universe 412 defines all of the course offerings of a college or university. All of a college or university's plurality of degree programs 413 can be mathematically assembled from the rules universe 411 and the course universe 412. The transcript loader 401 loads the transcripts 414 for every student at every institution. The degree analyzer 402 has an institution degree analyzer 415 for each of the plurality of degree programs at each of the plurality of colleges. The degree analyzer 402, and each of the institution degree analyzers 415, is fed information from the degree analyzer operation 50, and the curriculum analyzer operation 60.

FIG. 6 shows the degree analyzer operation 50, which is comprised of a degree analyzer flow 500, a degree analyzer cache 510, a cache retrieval 520, and access to the present invention's database 84. The degree analyzer flow 500 is comprised of a degree course and rules superset 501 for each of the plurality of degrees at each of the plurality of colleges. The degree course and rules superset 501 is fed by all of the plurality of transcripts 502 for each of the plurality of students at each of the plurality of colleges. The degree analyzer flow 500 loads the degree analyzer 402. The degree analyzer flow 500 also interoperates with the degree analyzer cache 510. The degree analyzer cache 510 is comprised of a plurality of transcripts, matched courses, missing courses, and course not in the superset 511 for each of the plurality of transcripts for each of the plurality of students at each of the plurality of colleges. The degree analyzer cache 510 transfers data from the cached data retrieval 520 to the degree analyzer flow 500. The cache retrieval 520 is composed of a data streaming script 521 which accesses the data from the present invention's database 84.

FIG. 5 shows the curriculum analyzer operation 60, which feeds the degree analyzer 402. The curriculum analyzer operation 60 is comprised of a curriculum analyzer flow 600, a degree analyzer cache 610 for the curriculum analyzer operation 60, a cache retrieval 520, and access to the present invention's database 84. The curriculum analyzer flow 600 is comprised of the degree course and rules superset 501 for each of the plurality of degrees at each of the plurality of colleges. The degree course and rules superset 501 is fed by all of the plurality of matched courses 602 for each of the plurality of degree programs at each of the plurality of colleges. The curriculum analyzer flow 600 loads the degree analyzer 402. The curriculum analyzer flow 600 also interoperates with the degree analyzer cache 610. The degree analyzer cache 610 is comprised of a plurality of degrees, matched courses, missing courses, course not in the superset, and the number of students for each of the foregoing 611 for each of the plurality of matched courses for each of the plurality of degree programs at each of the plurality of colleges. The degree analyzer cache 610 transfers data from the cached data retrieval 520 to the curriculum analyzer flow 600. The cache retrieval 520 is composed of a data streaming script 521 which accesses the data from the present invention's database 84.

The degree analyzer 402, comprised of an institution degree analyzer 415 for each of the plurality of degree programs at each of the plurality of colleges, constructs an algebraic Boolean expression out of the information supplied from the curriculum analyzer operation 60, the degree analyzer operation 50, the loaded transcripts 401, 414, and the rules universe 411, and courses universe 412 for each of the degree programs 413 at each of the plurality of colleges. The institution degree analyzer 415 determines whether each student and/or each transcript 414 meets the degree or graduation requirements using the algebraic Boolean expressions.

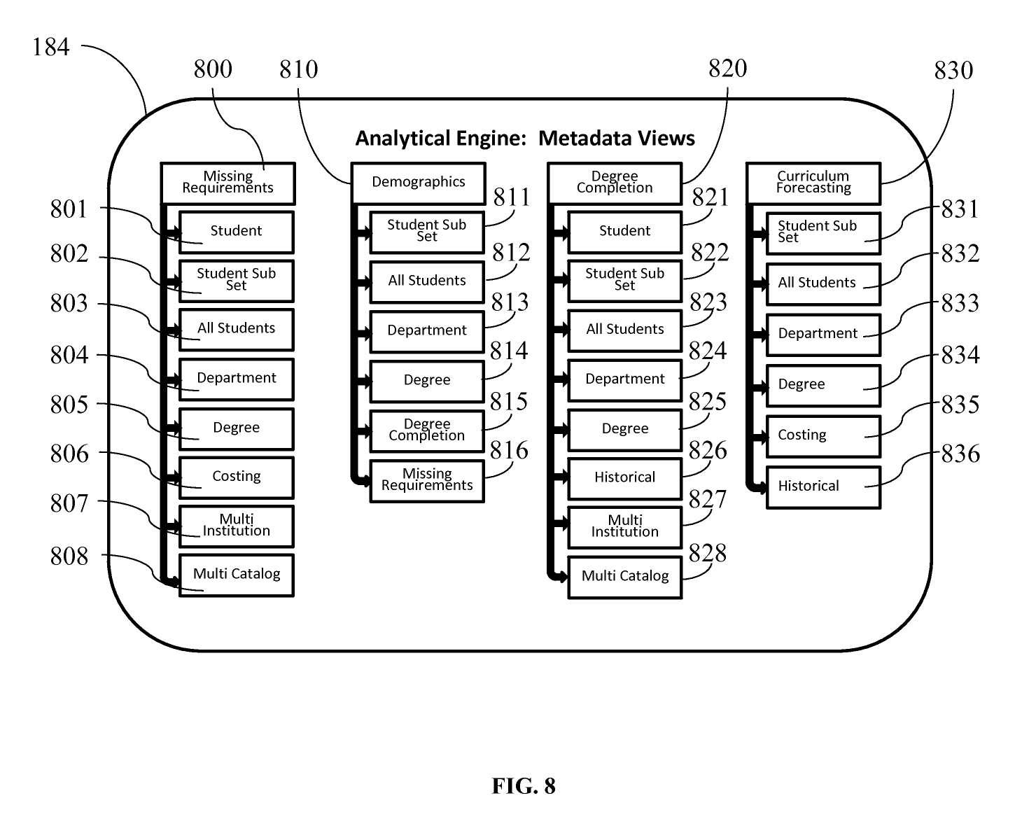

FIG. 8 shows an analytical engine database construct 184 for the present invention, which is resident in the present invention's database 84. The analytical engine database construct 184 stores metadata for missing requirements 800, demographics 810, degree completion 820, and curriculum forecasting 830. The missing requirements 800 is comprised of the missing requirements for each student 801, each defined student subset (e.g., by degree program or major) 802, all students 803, all departments 804, all degrees 805, all costing 806, multi-institution 807, and multi-catalog 808. The demographics is comprised of student subsets 811, all students 812, departments 813, degrees 814, degree completion 815, and missing requirements 816. The degree completion 820 metadata is comprised of student 821, student subset 822, all students 823, department 824, degree 825, historical 826, multi-institution 827, and multi-catalog 828. The curriculum forecasting 830 metadata is comprised of student subset 831, all students 832, departments 833, degree 834, costing 835, and historical 836.

I claim:

1. A method for analyzing the remaining required courses needed for completing a degree program for a student population at a post-secondary educational institution comprising obtaining the graduation requirements for all degree programs at the post-secondary educational institution;
converting the graduation requirements into a set of algebraic Boolean expressions; creating the appropriate algebraic Boolean sum to indicate that the degree or course of study requirements have been met;
identifying, for each course offered at the post-secondary educational institution, all of the uses for which the course may be used in meeting the requirements for all of the degree programs; accessing a student's record of completed course work and determining the remaining classes needed to complete the student's chosen or declared degree program.

2. The method for analyzing the remaining required courses needed for completing a degree program for a student population at a post-secondary educational institution in claim 1, further comprising aggregating the remaining required courses needed for completing a degree program for the entire student population at the post-secondary educational institution.

3. The method for analyzing the remaining required courses needed for completing a degree program for a student population at a post-secondary educational institution in claim 2, further comprising using the aggregated remaining course work to create a course scheduling forecast.

4. The method for analyzing the remaining required courses needed for completing a degree program for a student population at a post-secondary educational institution in claim 2, further comprising a reporting feature for the post-secondary educational institution, to track year-to-year and semester-to-semester progress for the aggregated remaining course work, with respect to a particular student and with respect to a particular sub-set of the student population.

5. A method for analyzing the remaining required courses needed for completing a degree program for a student population at a post-secondary educational institution comprising obtaining the graduation requirements for all degree programs at each post-secondary educational institution;
converting the graduation requirements into a set of algebraic Boolean expressions; creating the appropriate algebraic Boolean sum to indicate that the degree or course of study requirements have been met;
identifying, for each course offered at each post-secondary educational institution, all of the uses for which the course may be used in meeting the requirements for all of the degree programs; accessing a student's record of completed course work, for a student who has attended one or more of the plurality of post-secondary educational institutions, and determining the remaining classes needed to complete the student's chosen or declared degree program at the student's current post-secondary educational institution.

6. The method for analyzing the remaining required courses needed for completing a degree program for a student population at a post-secondary educational institution in claim 5, further comprising aggregating the remaining required courses needed for completing a degree program for each individual within the entire student population at each of the post-secondary educational institutions.

7. The method for analyzing the remaining required courses of study for a plurality of student populations at a plurality of post-secondary educational institutions in claim 6, further comprising allowing each post-secondary educational institution to track the educational progress of each formerly enrolled student, when the student has continued the student's education at another of the plurality of post-secondary educational institutions.

8. The method for analyzing the remaining required courses of study for a plurality of student populations at a plurality of post-secondary educational institutions in claim 7, further comprising a tracking feature, allowing each post-secondary educational institution to determine, for a given former student, when that student has met or exceeded certificate or degree requirements; so that the post-secondary educational institution can issue said certificate or degree, or report that the student has met graduation or certificate requirements.

9. The method for analyzing the remaining required courses of study for a plurality of student populations at a plurality of post-secondary educational institutions in claim 7, further comprising a reporting feature, allowing each post-secondary educational institution to determine, for a given period of time, the number of students who graduated or are still in school, regardless from which post-secondary educational institution the student graduated or of which post-secondary educational institution the student is currently enrolled.

10. The method for analyzing the remaining required courses of study for a plurality of student populations at a plurality of post-secondary educational institutions in claim 5, further comprising allowing each student to see their remaining course work to achieve their declared major.

11. The method for analyzing the remaining required courses of study for a plurality of student populations at a plurality of post-secondary educational institutions in claim 10, further comprising allowing each student to see the remaining course work required to graduate in any of the degree programs at any of the plurality of educational institutions, using the student's currently completed course work.

12. The method for analyzing the remaining required courses of study for a plurality of student populations at a plurality of post-secondary educational institutions in claim 11, further comprising allowing each student to calculate the cost of completing each degree program at any of the plurality of educational institutions, using the student's financial aid record, most recent Free Application for Federal Student Aid, or equivalent, and extrapolating, from a historical database, the estimated cost per credit hour the student would have to pay at each post-secondary educational institution.

13. The method for analyzing the remaining required courses of study for a plurality of student populations at a plurality of post-secondary educational institutions in claim 12, further comprising allowing each student, using the estimated cost per credit hour for each class for each degree program for each post-secondary educational institution, to aggregate a total cost for each degree program at each post-secondary educational institution, and allowing said student to compare the cost for each degree program at each post-secondary educational institution.

14. A system for analyzing the remaining required courses needed for completing a degree program for a student population at a post-secondary educational institution comprising a plurality of databases, a central processing unit, at least one input/output device, a means of communicating between the central processing unit and the plurality of databases, and computer program in the central processing unit, stored in durable, readable medium, comprising a capability of obtaining the graduation requirements for all degree programs at the post-secondary educational institution; converting the graduation requirements into a set of algebraic Boolean expressions; creating the appropriate algebraic Boolean sum to indicate that the degree or course of study requirements have been met; identifying, for each course offered at the post-secondary educational institution, all of the uses for which the course may be used in meeting the requirements for all of the degree programs; accessing a student's record of completed course work and determining the remaining classes needed to complete the student's chosen or declared degree program.

15. A system for analyzing the remaining required courses needed for completing a degree program for a student population at a post-secondary educational institution in claim 14, wherein the software program further comprises aggregating the remaining required courses needed for completing a degree program for the entire student population at the post-secondary educational institution.

16. The system for analyzing the remaining required courses needed for completing a degree program for a student population at a post-secondary educational institution in claim 15, wherein the software program further comprises using the aggregated remaining course work to create a course scheduling forecast.

17. The system for analyzing the remaining required courses needed for completing a degree program for a student population at a post-secondary educational institution in claim 15, further comprising a reporting feature for the post-secondary educational institution, to track year-to-year and semester-to-semester progress for the aggregated remaining course work, with respect to a particular student and with respect to a particular sub-set of the student population.

18. A system for analyzing the remaining required courses needed for completing a degree program for a student population at a post-secondary educational institution comprising a plurality of databases, a central processing unit, an input/output device, a means of communicating between the central processing unit and the plurality of databases, and computer program in the central processing unit, stored in durable, readable medium, comprising a capability of obtaining the graduation requirements for all degree programs at the post-secondary educational institution; converting the graduation requirements into a set of algebraic Boolean expressions; creating the appropriate algebraic Boolean sum to indicate that the degree or course of study requirements have been met;
identifying, for each course offered at the post-secondary educational institution, all of the uses for which the course may be used in meeting the requirements for all of the degree programs; accessing a student's record of completed course work and determining the remaining classes needed to complete the student's chosen or declared degree program.

19. The system for analyzing the remaining required courses needed for completing a degree program for a student population at a post-secondary educational institution claim 18, wherein the software program further comprises aggregating the remaining course work to meet graduation requirements for the entire student population at each of the post-secondary educational institutions.

20. The system for analyzing the remaining required courses needed for completing a degree program for a student population at a post-secondary educational institution in claim 19, wherein the software program further comprises allowing each post-secondary educational institution to track the educational progress of each formerly enrolled student, when the student has continued the student's education at another of the plurality of post-secondary educational institutions.

21. The system for analyzing the remaining required courses needed for completing a degree program for a student population at a post-secondary educational institution in claim 20, further comprising a tracking feature, allowing each post-secondary educational institution to determine, for a given former student, when that student has met or exceeded certificate or degree requirements; so that the post-secondary educational institution can issue said certificate or degree, or report that the student has met graduation or certificate requirements.

22. The system for analyzing the remaining required courses needed for completing a degree program for a student population at a post-secondary educational institution in claim 20, wherein the software program further comprises a reporting feature, allowing each post-secondary educational institution to determine, for a given period of time, the number of students who graduated or are still in school, regardless from which post-secondary educational institution the student graduated or of which post-secondary educational institution the student is currently enrolled.

23. The system for analyzing the remaining required courses needed for completing a degree program for a student population at a post-secondary educational institution in claim 18, wherein the software program further comprises allowing each student to see their remaining course work to achieve their declared major.

24. The system for analyzing the remaining required courses needed for completing a degree program for a student population at a post-secondary educational institution in claim 23, wherein the software program further comprises allowing each student to see the remaining course work required to graduate in any of the degree programs at any of the plurality of educational institutions, using the student's currently completed course work.

25. The system for analyzing the remaining required courses needed for completing a degree program for a student population at a post-secondary educational institution in claim 24, wherein the software program further comprises allowing each student to calculate the cost of completing each degree program at any of the plurality of educational institutions, using the student's financial aid record, most recent Free Application for Federal Student Aid, or equivalent, and extrapolating, from a historical database, the estimated cost per credit hour the student would have to pay at each post-secondary educational institution.

26. The system for analyzing the remaining required courses needed for completing a degree program for a student population at a post-secondary educational institution in claim 25, further comprising allowing each student, using the estimated cost per credit hour for each class for each degree program for each post-secondary educational institution, to aggregate a total cost for each degree program at each post-secondary educational institution, and allowing said student to compare the cost for each degree program at each post-secondary educational institution.
